(19) United States
(12) Patent Application Publication
(10) Pub. No.: US 2014/0123598 A1
(43) Pub. Date: May 8, 2014

(54) Device for opening a gas pressure container, cold gas generator and method for manufacturing a cold gas generator

(71) Applicants: Uwe IBEN, Gerlingen (DE); Werner Nitschke, Asperg (DE)

(72) Inventors: Uwe IBEN, Gerlingen (DE); Werner Nitschke, Asperg (DE)

(73) Assignee: Robert Bosch GmbH, Stuttgart (DE)

(21) Appl. No.: 14/070,721

(22) Filed: Nov. 4, 2013

(30) Foreign Application Priority Data
Nov. 5, 2012 (DE) 10 2012 220 061.4

(51) Int. Cl. F17C 1/00; B60R 21/33; B60R 21/274

(52) U.S. Cl. CPC F17C 1/00; B60R 21/274; B60R 21/33
USPC 53/403; 53/285

(57) ABSTRACT

A device for opening a gas pressure container includes: a rupture disk; and an explosive charge. The rupture disk is configured to seal the gas pressure container in a gas-tight manner. The explosive charge, which is situated in direct contact with a surface of the rupture disk, ruptures the rupture disk in response to an ignition impulse.

### BACKGROUND OF THE INVENTION

1. Field of the Invention

The present invention relates to a device for opening a gas pressure container, to a cold gas generator and to a method for manufacturing a cold gas generator.

2. Description of the Related Art

In modern vehicles, cold gas generators are increasingly being used for inflating personal safety means such as air bags, in order to avoid an explosion of a large quantity of blasting agents making a loud noise and a large quantity of hot gas in the vicinity of a vehicle passenger, so as to reduce the endangerment of a vehicle passenger.

Published German patent application document DE 10 2004 009 300 A1 describes a vehicle passenger device.

### BRIEF SUMMARY OF THE INVENTION

The present invention provides a device for opening a gas pressure container, a cold gas generator as well as a method for manufacturing a cold gas generator.

An explosion is able to act more forcefully upon an object via pressure and temperature the lower the distance of the explosion from the object. The stronger the effect of the explosion, the smaller the total energy of the explosion needs to be to achieve the same effect.

The explosion may advantageously take place directly on the object, in order to destroy the object reliably using the minimum quantity of blasting agent.

A device for opening a gas pressure container is provided, the device having the following features:

a rupture disk for the gas-tight sealing of the gas pressure container; and

an explosive charge for destroying the rupture disk, in response to an ignition impulse, the explosive charge being situated in direct contact to a surface of the rupture disk.

In addition, a cold gas generator is provided having the following features:

a gas pressure container which is filled with a compressed cold gas in an operation-ready state; and

a device for opening the gas pressure container according to the design approach presented in this instance, in the operation-ready state of the cold gas generator, the rupture disk sealing the outlet opening of the gas pressure container in a gas-tight manner.

Furthermore, a method is provided for manufacturing a cold gas generator, the method having the following steps:

filling a gas pressure container with a compressed cold gas; and

sealing an outlet opening of the gas pressure container, using a device for opening according to the approach presented in this instance.

By a gas pressure container one may understand a pressure-resistant container that is developed to stock up compressed gas. The gas may be designated as cold gas, since the gas has a temperature that is less than, or equal to the environmental temperature when it flows out. By contrast to this, combustion gases, such as are created in response to the explosion of blasting agents, might be designated as hot gas. The gas pressure container may be designated as a pressure cartridge. In analogous fashion to a compressed-air cylinder, the gas pressure container may have a basic cylindrical shape having an arched bottom and arched shoulders. The gas pressure container may also be spherical, for example. The gas pressure container may be made of a high pressure stressable material and have great wall strength. A rupture disk may be a diaphragm that is strong enough to endure the pressure of the compressed gas in the gas pressure container, as long as no additional external forces act upon the rupture disk. The rupture disk is permanently gas-tight. When a greater force than a force that is provided acts upon the rupture disk, the rupture disk fails, and thereby becomes permeable to the gas. An explosive charge may be a quantity of explosive material that is sufficient to destroy the rupture disk in combinations with the pressure in the gas pressure container when the explosive charge is ignited. The explosive charge may include an ignition device. The ignition device may be activated by an ignition impulse. The explosive charge may include an explosive material. The explosive charge may have a predetermined shape, in order, for instance, locally to reinforce the explosive force of the explosive charge, or to steer it in a preferred direction. The diaphragm may be situated directly on the rupture disk. If the explosion takes place directly on the rupture disk, the effect is great. The effect may be increased if the force is concentrated on the rupture disk or if the explosion takes place within the rupture disk. A cold gas generator may be part of an energy absorption device. The cold gas generator may, for instance, be part of an air bag system. The cold gas generator may provide gas for inflating the air bag when the rupture disk is destroyed by a triggering signal.

The cold gas generator may have a controllable valve for regulating a gas flow through the exit opening during the activation of the cold gas generator. After the ignition of the explosive charge, the valve may regulate the gas flow from out of the gas pressure container. Because of this, for example, the gas bag may be partially inflated. The gas bag may also be inflated in a step-wise manner. A prolonged service life of the air bag at a predetermined filling level is also made possible by pulsed gas impulses from the gas pressure container, for example.

The rupture disk may be welded together with the gas pressure container. By being welded together, the rupture disk may be connected permanently and securely to the gas pressure container. The welding together may take place using laser welding, for example. The welding together may take place for sealing the gas pressure container directly after the filling process.

The explosive charge may be situated directly at a weak point on the rupture disk. A weak point may, for instance, be a point on the rupture disk at which in the material of the rupture disk the largest stresses are present when the rupture disk is under pressure. The weak point may, for instance, be situated at a place in the rupture disk that has a notch. The weak point may also be situated at a place at which the rupture disk has a lower material strength than at other places.

The rupture disk may have at least one notch, this notch being developed as a predetermined breaking point. A notch may be a groove. The notch may be a longitudinal depression. If the rupture disk has a plurality of notches, the notches may intersect. The rupture disk may be structurally weakened by the notch, so that the rupture disk fails or breaks at the notch, when the explosive charge is ignited. A destruction pattern of the rupture disk may be predetermined by inserting the notch, whereby the gas is able to flow out of the gas pressure container in a predetermined manner.

The device may have a second rupture disk which is situated so that the explosive charge is situated between the rupture disk and the second rupture disk. The second rupture disk may essentially be the same as the first rupture disk. The second rupture disk may be situated on the side of the rupture disk facing away from the gas pressure container. The second rupture disk may not be acted upon by the pressure in the gas pressure container. During manufacture, the second rupture disk may be mounted on the gas pressure container after the first rupture disk. The explosive charge may be situated in a protected manner between the rupture disks.

The second rupture disk may have an accommodation for the explosive charge, for instance, a spacing ring. During the manufacture of the cold gas generator, the second rupture disk may be situated with the explosive charge in the accommodation on the rupture disk after the gas pressure container has been sealed in a gas-tight manner by the first rupture disk. By the subsequent application of the explosive charge, the rupture disk may be connected to the gas pressure container in a simple manner. The explosive charge may be placed on the rupture disk in a separate working process, and without thermal effects on the rupture disk.

The second rupture disk may have electric circuit traces for conducting the ignition impulses. The second rupture disk may have through-contactings which are able to conduct the ignition impulse to the explosive charge. The explosive charge may thereby be ignited via freely accessible terminals.

The rupture disk and the second rupture disk may have notches, the notches being aligned towards one another particularly in that the electric circuit traces are situated in the notches or are guided through the spacing ring. Notches aligned towards one another may be congruent notches, so that these notches form channels. In the channels, the electric lines may be situated for igniting the explosive charge. The explosive charge may thereby be situated centrically on the rupture disk and be easy to ignite from the outside, without, by the embedding of the lines, the rupture disk being weakened at certain places by the embedding of the lines.

The second rupture disk may be prestressed with respect to the first rupture disk, in order to clamp the explosive charge between the rupture disk and the second rupture disk. The second rupture disk may, for instance, be pressed onto the rupture disk at one edge. The second rupture disk may thereby be elastically deformed, and the explosive charge may be pressed onto the first rupture disk using a spring force of the second rupture disk. In the unstressed state, the second rupture disk may also have an opposite shape of the rupture disk. During the manufacture of the cold gas generator, the second rupture disk may be bent into the same shape as the rupture disk.

### BRIEF DESCRIPTION OF THE DRAWINGS

FIG. 1 shows a block circuit diagram of a cold gas generator according to an exemplary embodiment of the present invention.

FIG. 2 shows a flow chart of a method for manufacturing a cold gas generator according to an exemplary embodiment of the present invention.

FIG. 3 shows an illustration of a cold gas generator according to an exemplary embodiment of the present invention.

FIG. 4 shows an illustration of a device for opening a gas pressure container according to an exemplary embodiment of the present invention.

FIG. 5 shows an illustration of a device having two rupture disks according to an exemplary embodiment of the present invention.

### DETAILED DESCRIPTION OF THE INVENTION

In the subsequent description of preferred exemplary embodiments of the present invention, the same or similar reference numerals are used for the elements that are shown in the various figures and act similarly; a repeated description of these elements has been dispensed with.

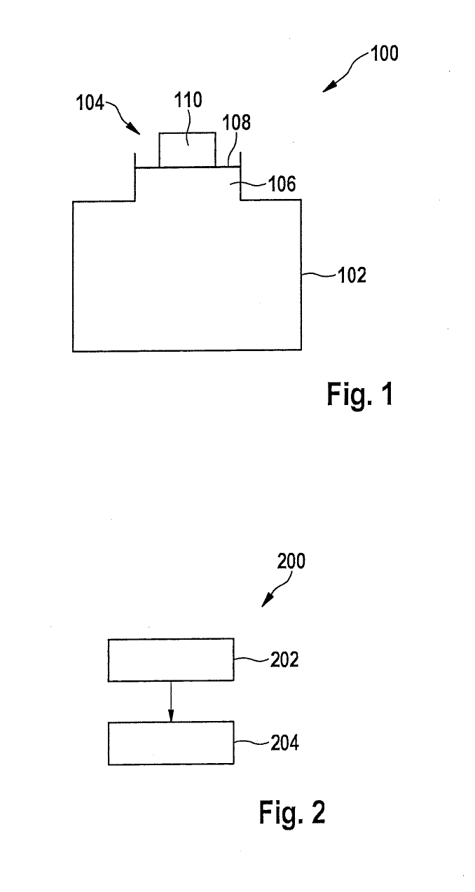

FIG. 1 shows a block circuit diagram of a cold gas generator 100 according to one exemplary embodiment of the present invention. Cold gas generator 100 has a gas pressure container 102 and a device 104 for opening gas pressure container 102. Gas pressure container 102 is pressure-resistant and, has a discharge opening 106. During its manufacturing, gas pressure container 102 is able to be filled with compressed cold gas through discharge opening 106. Subsequently, discharge opening 106 has been sealed in a gas-tight manner by device 104. Device 104 has a rupture disk 108 and an explosive charge 110 for destroying rupture disk 108. Rupture disk 108 is situated transversely to discharge opening 106 and seals it completely and in a gas-tight manner. Rupture disk 108 is develped as a diaphragm and is designed so that it is able to resist the pressure of the cold gas and is sealed permanently. Explosive charge 110 is situated directly on a surface of rupture disk 108. Explosive charge 110 is developed so that when there is ignition in response to an ignition impulse, it exerts a force on rupture disk 108 which, in combination with a pressure force because of the pressure in gas pressure container 102, is greater than the force of resistance of rupture disk 108. Explosive charge 110 is situated on the outside on rupture disk 108, in this exemplary embodiment. The explosive charge may also be situated in gas pressure container 102.

In other words, FIG. 1 shows a cold gas generator 100 having a rupture disk 108, which is able to be used as a component of an actuating system for the passive safety of the passengers of a vehicle.

Cold gas generators may be equipped with usual firing pellets for opening a gas pressure container. In this context, a plurality of functioning methods is possible for opening the pressure container. For instance, a pressure wave may be generated, which runs from one end of the container to the other end, and there destroys a diaphragm. The firing pellet may also generate heat, which destroys a diaphragm. The firing pellet may also accelerate a taper plug which destroys the diaphragm. Or, the firing pellet moves a lever which supports the diaphragm, so that the diaphragm fails.

By the approach just provided, it is possible to destroy a gas-tight diaphragm 108, using as little explosive material 110 as possible. This enables one to achieve a simpler handling of pressure container 102, since only small quantities of explosive material 110 are required for destroying diaphragm 108. The small quantities of dangerous materials represent a smaller accident risk. In order to achieve the greatest effect of explosive charge 110, explosive material 110 is situated in direct contact with diaphragm 108.

FIG. 2 shows a flow chart of a method 200 for manufacturing a cold gas generator, according to one exemplary embodiment of the present invention. Method 200 has a step 202 of filling and a step 204 of sealing. By the method

a cold gas generator, as shown in FIG. 1, is able to be manufactured. In step 202, a gas pressure container is filled with a compressed cold gas. In step 204, a discharge opening of the gas pressure container having a device for opening, as provided in this context, is sealed in a gas-tight manner.

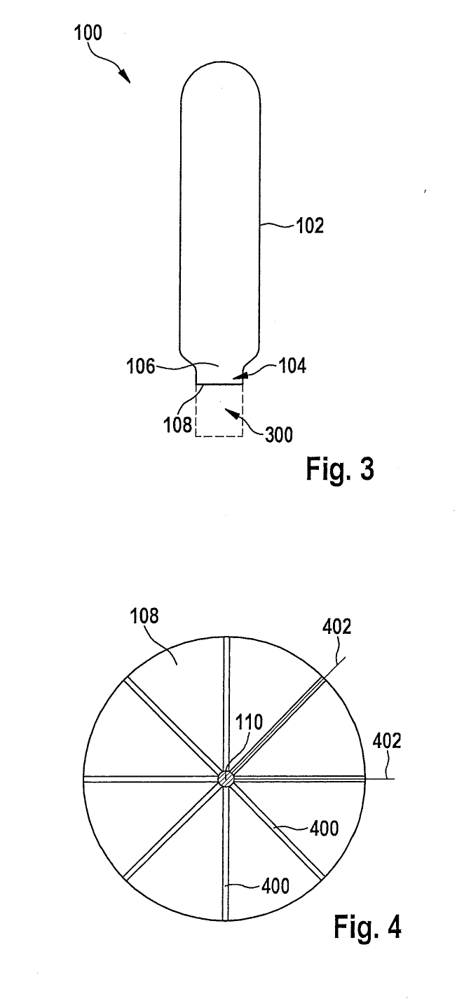

FIG. 3 shows an illustration of a cold gas generator 100 according to an exemplary embodiment of the present invention. As in FIG. 1, cold gas generator 100 has a gas pressure container 102 and a device 104 for opening according to the approach provided in this connection. The gas pressure container or tank 102 has a cylindrical base body having an arched floor and shoulder. In this case, gas pressure container 102 is shown having a shoulder at the bottom. In the vicinity of the shoulder, gas pressure container 102 has a discharge opening 106. In this exemplary embodiment, gas pressure container 102 is developed to be connected to an air bag. Discharge opening 106 is sealed by device 104. The gas pressure container is filled with a cold gas under high pressure, Because of the pressure in gas pressure container 102, rupture disk 108 is arched outwards. In the closed state, device 104 prevents the cold gas from flowing to the air bag through an outlet 300 that borders on discharge opening 106.

In other words, FIG. 3 shows a schematic representation of tank 102, rupture disk 108 and outlet opening 300, which represents the outlet to the air bag.

FIG. 4 shows a representation of a device 104 for opening a gas pressure container according to an exemplary embodiment of the present invention. Device 104 has a rupture disk 108 and an explosive charge 110. Rupture disk 108 is round and has two or more notches 400 that intersect regularly in star form. In the vicinity of notches 400, the material strength of rupture disk 108 is reduced. This makes notches 400 the predetermined breaking points for rupture disk 108. Explosive charge 110 is situated in the middle of rupture disk 108, at a point of intersection of notches 400. Explosive charge 110 is situated directly on a surface of rupture disk 108, in a depression in rupture disk 108 resulting at the point of intersection. Explosive charge 110 is very small compared to rupture disk 108. Explosive charge 110 is situated at a weak point of rupture disk 108. Two electric lines 402 to explosive charge 110 are situated in two adjacent notches 400 or are situated guided through a spacer. Electric lines 402 are connected via an ignition device for explosive charge 110. The ignition device is integrated in explosive charge 110.

In other words, FIG. 4 shows a schematic representation of rupture disk 108 having embossings 400, electric supply line 402 and explosive charge 110 made of explosive material. Embossings 400 are depressions in rupture disk 108.

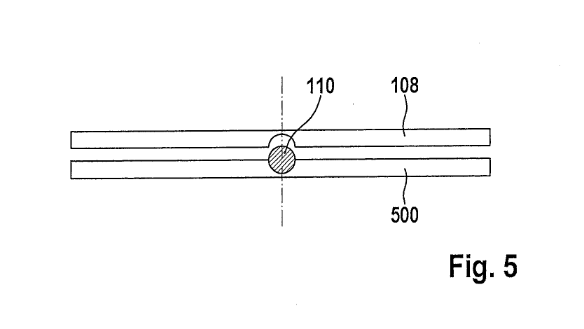

FIG. 5 shows a representation of a device 104 having two rupture disks 108, 500 according to an exemplary embodiment of the present invention. The device may correspond to the device in FIG. 1, for example. In addition to the device in FIG. 1, device 104 shown here has a second rupture disk 500. Rupture disk 108 and second rupture disk 500 are congruently situated one over the other. There is a slight air gap between the two rupture disks 108, 500. Second rupture disk 500 is executed as a reflection of rupture disk 108. In the center of circular rupture disks 108, 500, on the side respectively facing the other rupture disk 108, 500, a depression is situated in each case, so that, at this location, a cavity is developed between rupture disks 108, 500. Explosive charge 110 is situated in the cavity by the notches or the spacer. Explosive charge 110 is fastened on second rupture disk 500, and is pressed by second rupture disk 500 into rupture disk 108, so that explosive charge 110 is situated directly on the surface of rupture disk 108. The depression in second rupture disk 500 is thus used as an accommodation for explosive charge 110. As shown in the exemplary embodiment in FIG. 4, if rupture disks 108, 500 have notches, the notches are also situated congruently, in order to ensure the breaking of the two rupture disks 108, 500 along the notches, when explosive charge 110 is fired.

In other words, FIG. 5 shows a schematic representation of rupture disks 108, 500 as a composite. Explosive material 110 is situated between first rupture disk 108 and second rupture disk 500, in this context.

FIGS. 3, 4 and 5 will now be described in other words below. Between a pressure container 102 (tank) and an outlet opening 200 to the air bag, a rupture disk 108 is mounted (FIG. 3). Outlet opening 300 to the air bag may be released directly or opened or blocked by a valve connected in between. Adaptive air bags may thereby be implemented. Rupture disk 108 has impressions 400 (notches), which are used as specifications for later lines of fracture of rupture disk 108. In the middle of disk 108 all depressions 400 run together (FIG. 4). This is where explosive charge 110 is placed. In order for it to be able to be ignited electrically, electric supply 402 is guided to the middle in depressions 400 of diaphragm 108. Two identical rupture disks may be inserted as a composite (FIG. 5). First rupture disk 108 is sealed using the bottom of pressure container 102 (e.g. by laser welding) and second rupture disk 500 is assembled as a reflection of first rupture disk 108 (for instance, screwed to the part that includes the outlet openings and the valve). Second rupture disk 500 may include explosive material 110. Thereby no stressing of explosive material 110 is created by welding processes. That being the case, explosive agent 110 is located between the two rupture disks 108, 500, and cannot be released from the material by temperature change, since it is clamped in. The effect of explosive agent 110 is now optimal, since it is positioned directly at the weakest place of rupture disk 108.

The exemplary embodiments described and shown in the figures have been selected merely as examples. Different exemplary embodiments are combinable with one another, either completely or with regard to individual features. An exemplary embodiment may also be supplemented by features from another exemplary embodiment.

Furthermore, method steps according to the present invention may be carried out repeatedly and also performed in a sequence other than the one described.

What is claimed is:

1. A device for sealing and selectively opening a gas pressure container, comprising:
at least one rupture disk providing a gas-tight sealing of the gas pressure container; and
an explosive charge for rupturing the rupture disk in response to an ignition impulse, wherein the explosive charge is situated in direct contact with a surface of the at least one rupture disk.

2. The device as recited in claim 1, wherein the explosive charge is situated at a weak point of the rupture disk provided as a predetermined breaking point of the rupture disk.

3. The device as recited in claim 2, wherein the rupture disk has at least one notch configured as the predetermined breaking point of the rupture disk.

4. The device as recited in claim 1, wherein two rupture disks are provided, and wherein the explosive charge is situated between the two rupture disks.

5. The device as recited in claim 4, wherein one of the two rupture disks has an accommodation for the explosive charge.

6. The device as recited in claim 4, wherein the two rupture disks each have notches, the notches of the two rupture disks being aligned with one another, and wherein electrical circuit traces are situated in at least one of the notches.

7. The device as recited in claim 4, wherein a first one of the two rupture disks is prestressed with respect to a second one of the two rupture disks in order to clamp the explosive charge between the two rupture disks.

8. A cold gas generator, comprising:
a gas pressure container filled with a compressed cold gas in an operation-ready state; and
a device for sealing and selectively opening the gas pressure container, the device having:
at least one rupture disk providing a gas-tight sealing of an outlet opening of the gas pressure container in the operation-ready state; and
an explosive charge for rupturing the rupture disk in response to an ignition impulse, wherein the explosive charge is situated in direct contact with a surface of the at least one rupture disk.

9. The cold gas generator as recited in claim 8, further comprising:
a controllable valve for regulating a gas flow through the outlet opening of the cold gas generator during an activation of the cold gas generator.

10. A cold gas generator as recited in claim 8, wherein the rupture disk is welded to the gas pressure container.

11. A method for manufacturing a cold gas generator, comprising:
filling a gas pressure container with a compressed cold gas; and
sealing an outlet opening of the gas pressure container using a device for sealing and selectively opening the gas pressure container, the device having:
at least one rupture disk providing a gas-tight sealing of the outlet opening of the gas pressure; and
an explosive charge for rupturing the rupture disk in response to an ignition impulse, wherein the explosive charge is situated in direct contact with a surface of the at least one rupture disk.
